(19) United States
(12) Patent Application Publication
(10) Pub. No.: US 2025/0349267 A1
(43) Pub. Date: Nov. 13, 2025

(54) DISPLAY CONTROL METHOD AND DEVICE FOR DISPLAY PANEL, AND DISPLAY SYSTEM

(71) Applicant: NOVATEK MICROELECTRONICS CORP., Hsinchu (TW)

(72) Inventors: Chuang-Cheng Yang, Zhubei (CN); Wen-Chin Cheng, Zhubei (CN); Jen-Ta Yang, Zhubei (CN); Hsien-Po Huang, Hsinchu (CN); Hao Fang, Chongqing (CN)

(21) Appl. No.: 18/974,200

(22) Filed: Dec. 9, 2024

Related U.S. Application Data
(60) Provisional application No. 63/643,428, filed on May 7, 2024.

(30) Foreign Application Priority Data
Jul. 30, 2024 (CN) 202411030038.3

(51) Int. Cl. G09G 3/34; G09G 3/20; G09G 3/36

(52) U.S. Cl. CPC G09G 3/3406; G09G 3/2007; G09G 3/2096; G09G 3/3685; G09G 2310/027; G09G 2320/0242

(57) ABSTRACT

A display control method and device for a display panel and a display system are provided. The display control method for the display panel includes: acquiring duty ratio information for controlling a backlight module; determining a target data voltage of each pixel on the display panel based at least in part on the duty ratio information; and applying the target data voltage to data lines on the display panel to control the display panel for display.

### CROSS-REFERENCE TO RELATED APPLICATIONS

This disclosure claims the priority of U.S. provisional application No. 63/643,428 filed on May 7, 2024 and the priority of Chinese patent application No. 202411030038.3 filed on Jul. 30, 2024, the contents of which are incorporated into this disclosure by reference in its entirety.

### TECHNICAL FIELD

The present disclosure relates to a field of display technology, and more particularly, to a display control method and device for a display panel, and a display system.

### BACKGROUND

In the field of display technology, a liquid crystal display (LCD) is widely used in various electronic products due to its lightness and thinness, low power consumption, and the like. The LCD utilize a backlight to provide necessary brightness to display images. In an LCD backlighting system, color temperature consistency is critical for providing high quality display effects. An ideal backlight system should be able to maintain consistency in color temperature at different pulse width modulation (PWM) duty ratios.

However, limited by material properties of LCD backlights or problems in their design, manufacture, etc., backlights with poor quality may occur, which may experience inconsistencies or deviations in color temperature as the duty ratio varies, and the deviations may be outside of a tolerable range, thereby degrading image quality, and also causing visual fatigue to users and degrading the user experience.

Therefore, there is a need for a solution capable of reducing the color temperature deviation of the backlight source due to the duty ratio variation, thereby providing a more stable and high-quality display effect.

### SUMMARY

To this end, the present disclosure proposes a display control method and device for a display panel, and a display system.

According to an aspect of the present disclosure, there is provided a display control method for a display panel, comprising: acquiring duty ratio information for controlling a backlight module; determining a target data voltage of each pixel on the display panel based at least in part on the duty ratio information; and applying the target data voltage to data lines on the display panel to control the display panel for display.

In one example, determining the target data voltage of each pixel on the display panel based at least in part on the duty ratio information comprises: adjusting display gray-level data for each pixel on the display panel based on the duty ratio information to obtain adjusted display gray-level data; and, generating the target data voltage based on the adjusted display gray-level data.

In one example, adjusting the display gray-level data for each pixel on the display panel based on the duty ratio information to obtain the adjusted display gray-level data comprises: determining a gray-level adjustment gain based on the duty ratio information; and, adjusting the display gray-level data for each pixel on the display panel based on the gray-level adjustment gain to obtain the adjusted display gray-level data.

In one example, the gray-level adjustment gain comprises a gray-level adjustment gain corresponding to one or more colors, and adjusting the display gray-level data for each pixel on the display panel based on the duty ratio information to obtain the adjusted display gray-level data comprises: determining the gray-level adjustment gain corresponding to the one or more colors based on the duty ratio information; and, adjusting the display gray-level data of sub-pixels of a corresponding color based on the gray-level adjustment gain corresponding to the one or more colors to obtain the adjusted display gray-level data.

In one example, determining the gray-level adjustment gain based on the duty ratio information comprises: determining the gray-level adjustment gain by a pre-stored look-up table, wherein the look-up table is used to record each of a plurality of duty ratios and a corresponding gray-level adjustment gain.

In one example, determining the target data voltage of each pixel on the display panel based at least in part on the duty ratio information comprises: determining a voltage adjustment gain based on the duty ratio information; and, adjusting a data voltage of each pixel on the display panel based on the voltage adjustment gain to obtain the target data voltage.

In one example, the voltage adjustment gain comprises a voltage adjustment gain corresponding to one or more colors, and determining the target data voltage of each pixel on the display panel based at least in part on the duty ratio information comprises: determining the voltage adjustment gain corresponding to the one or more colors based on the duty ratio information; and, adjusting a data voltage of sub-pixels of a corresponding color based on the voltage adjustment gain corresponding to the one or more colors to obtain the target data voltage.

In one example, determining the voltage adjustment gain based on the duty ratio information comprises: determining the voltage adjustment gain by a pre-stored look-up table, wherein the look-up table is used to record each of a plurality of duty ratios and a corresponding voltage adjustment gain.

According to another aspect of the present disclosure, there is provided a display control device for a display panel, comprising: means for acquiring duty ratio information for controlling a backlight module; means for determining a target data voltage of each pixel on the display panel based at least in part on the duty ratio information; and, means for applying the target data voltage to data lines on the display panel to control the display panel for display.

According to yet another aspect of the present disclosure, there is provided a display system, comprising: a display panel; a backlight module; an adjustment module, configured to: acquire duty ratio information for controlling the backlight module; adjust display gray-level data of each pixel on the display panel based on the duty ratio information to obtain adjusted display gray-level data; and, a source driver, configured to generate a target data voltage of each pixel on the display panel based on the adjusted display gray-level data, and to apply the target data voltage to data lines on the display panel to control the display panel for display.

In one example, the display system further comprises a timing controller, and the adjustment module is located inside the timing controller.

According to still another aspect of the present disclosure, there is provided a display system, comprising: a display panel; a backlight module; a determination module, configured to: acquire duty ratio information for controlling the backlight module; determine a voltage adjustment gain based on the duty ratio information; and, a source driver, configured to adjust a data voltage of each pixel on the display panel based on the voltage adjustment gain to obtain a target data voltage, and to apply the target data voltage to data lines on the display panel to control the display panel for display.

In one example, the display system further comprises a timing controller, and the determination module is located inside the timing controller.

In one example, the determining module is located inside the source driver.

In order that the above-described features and advantages of the present disclosure may be more clearly understood, embodiments will be set forth in the following detailed description taken in conjunction with the drawings.

### BRIEF DESCRIPTION OF THE DRAWINGS

The drawings are used to provide further understanding of the embodiments of the present disclosure, and constitute a part of the specification, which are used together with the embodiments of the present disclosure to explain the present disclosure, and do not constitute a limitation of the present disclosure. In the drawings, a same reference numeral generally represents same components or steps.

FIG. 1 shows a schematic diagram of LCD display system 100 in prior art.

FIG. 2 shows a display control method 200 for a display panel according to an embodiment of the present disclosure.

FIG. 3 shows a schematic diagram of an LCD display system 300 according to an embodiment of the present disclosure.

FIG. 4 shows a schematic diagram of an LCD display system 400 according to an embodiment of the present disclosure.

FIG. 5 shows a schematic diagram of an LCD display system 500 according to an embodiment of the present disclosure.

### DETAILED DESCRIPTION

Hereinafter, embodiments of the present disclosure will be described in detail with reference to the drawings and embodiments, whereby how the present disclosure applies technical means to solve the technical problems, and implementation processes to achieve the technical effects can be fully understood and implemented. It should be noted that, as long as there is no conflict, the various embodiments and the various features of the various embodiments in the present disclosure may be combined with each other, and the resulting solution is within the protection scope of the present disclosure.

Also, in the following description, for the purposes of explanation, numerous specific details are set forth in order to provide a thorough understanding of embodiments of the present disclosure. However, it will be apparent to one skilled in the art that the present disclosure may be practiced without the specific details or in the specific manner described herein.

Color temperature is a parameter describing the temperature of the color of a light source, the magnitude of which is usually measured by using Kelvin (K) as a unit. In an RGB color model, if gray-level values of red (R), green (G), and blue (B) sub-pixels are each set to a maximum value of 255, then the light emitted by the three sub-pixels is mixed together into white light with a color temperature visually close to the standard color temperature 6500K (standard white light). Ideally, a backlight for a liquid crystal display (LCD) should maintain consistency in color temperature at different pulse width modulation (PWM) duty ratios. Specifically, on the basis of the standard 6500K color temperature, with the gray-level values of the three RGB sub-pixels each set to 255, the fluctuation of the color temperature should preferably be controlled within a range of ±100K (i.e., 6400K to 6600K) for different PWM duty ratios, as shown in Table 1 below, for example.

TABLE 1

| PWM duty ratio | Color Temperature (K) |
|---|---|
| 0-100% | 6400-6600 |

However, limited by material properties of LCD backlights or problems in their design, manufacture, etc., backlights with poor quality may occur, which may exhibit inconsistencies or deviations in color temperature as the duty ratio varies. Specifically, also taking the case where the gray-level values of the three RGB sub-pixels are each set to 255 as an example, at different PWM duty ratios, a certain backlight source with poor quality may cause severe fluctuations in color temperature, which may exceed the tolerance range of ±100K (i.e., 6400K to 6600K), for example, as shown in Table 2 below.

TABLE 2

| PWM duty ratio | Color Temperature (K) |
|---|---|
| 0-30% | 6400-6600 |
| 30-70% | 6100-6500 |
| 70-100% | 6500-6800 |

In order to solve the above problem, in the embodiments according to the present disclosure, display gray-level data or a data voltage of RGB pixels will be adjusted according to the variation of PWM duty ratios, thereby achieving the reduction of color temperature deviation due to duty ratio variation, so as to provide a more stable and high quality display effect.

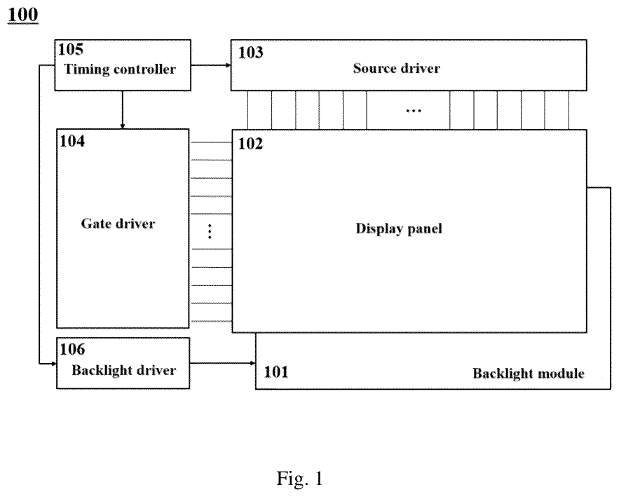

FIG. 1 shows a schematic diagram of LCD display system 100 in prior art. As described in FIG. 1, the LCD display system 100 includes a backlight module 101, a display panel 102, a source driver 103, a gate driver 104, a timing controller 105, and a backlight driver 106.

Among them, a plurality of RGB pixels (not shown) are included on the display panel 102, and each RGB pixel may consist of three sub-pixels corresponding to red (R), green (G), blue (B), respectively. Various colors may be produced by adjusting the brightness/gray level of respective sub-pixels of each RGB pixel. When performing display driving, the gate driver 104 may receive a control signal from the timing controller 105 to activate a certain row of pixels on the display panel 102, and subsequently, the source driver 103 may utilize a gamma voltage generator and a plurality of channel circuits (not shown) included therein, to output data voltages based on RGB display gray-level data (also referred to as pixel data or gray-level values, etc.) of respective pixels received from the timing controller 105, so as to apply the data voltages onto respective data channels/data lines of the display panel 102, where each data channel/data line may correspond to a sub-pixel of a certain color of one RGB pixel. The backlight module 101 may be used to provide uniform light rays to the display panel 102, and the backlight driver 106 may adjust the switching time of the backlight module 101 according to PWM output control signal received from the timing controller 105, thereby controlling the brightness of the backlight module 101.

Note that the backlight module 101 is shown staggered from the display panel 102 for clarity in FIG. 1, but actually the backlight module 101 is located directly behind the display panel 102. Also, the LCD display system 100 may include more or less modules or components as needed, without limitation herein.

As previously described, limited by material properties or problems in the process of its design, manufacture, etc., the backlight module 101 may experience deviations or inconsistencies in color temperature when PWM duty ratio varies. Therefore, in the embodiments of the present disclosure, the display gray-level data or the data voltage of respective pixels may be adjusted according to the variation of PWM duty ratios for controlling the backlight module, thereby reducing the color temperature deviation.

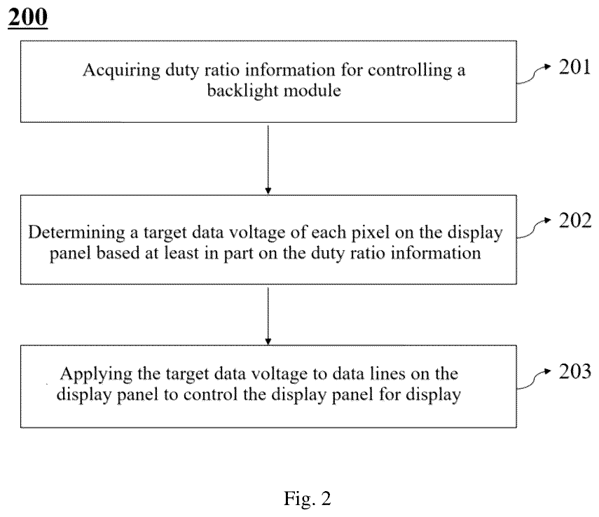

FIG. 2 shows a display control method 200 for a display panel according to an embodiment of the present disclosure.

As shown in FIG. 2, in step S201, duty ratio information for controlling a backlight module is acquired. Referring again to FIG. 1, in general, the timing controller 105 may receive the duty ratio information for controlling the backlight module from an external device such as a GPU. In one example, the duty ratio information may be the duty of the PWM control signal, which reflects the ratio of the light-up time of the backlight to the entire PWM period and determines the brightness of the backlight. In this example, the value of the duty ratio may be used directly for subsequent steps. In another example, the duty ratio information may be a PWM control signal having a particular duty ratio. Accordingly, in this example, the PWM control signal may be processed to determine its duty ratio for subsequent steps.

In step S202, a target data voltage of each pixel on a display panel is determined based at least in part on the duty ratio information.

As previously described, the embodiments according to the present disclosure may adjust the display gray-level data as a digital value or adjust the data voltage as an analog value to reduce the color temperature deviation. Next, an embodiment in which the display gray-level data is adjusted and the target data voltage is generated based on the adjusted display gray-level data will first be described. Another embodiment that directly adjusts the data voltage to generate the target data voltage is described in a subsequent section.

Specifically, in this embodiment where the adjustment is made to the display gray-level data, determining the target data voltage of each pixel on the display panel based at least in part on the duty ratio information comprises: adjusting display gray-level data for each pixel on the display panel based on the duty ratio information to obtain adjusted display gray-level data; and, generating the target data voltage based on the adjusted display gray-level data.

In this embodiment, before performing the above steps, it is necessary to first determine the gray-level adjustment gains which can be used for adjusting the display gray-level data to achieve a standard color temperature by an experiment, and store them beforehand in a memory of the display device. Specifically, during the experiment, the initial display gray-level data of each pixel on the display panel may each be set to a maximum value. For example, in the case of an 8-bit system with a gray-level value range of 0 to 255, the initial RGB display gray-level data of each pixel may each be set to (255, 255, 255). Subsequently, the initial display gray-level data may be adjusted by using different gray-level adjustment gains at each PWM duty ratio respectively (i.e., different gray-level adjustment gains are multiplied with the initial display gray-level data to obtain adjusted display gray-level data), and after display control/driving based on the adjusted display gray-level data, the color temperature of one or more pixels on the display panel is measured with a color temperature measurement device such as a color temperature meter, a color calibrator, etc. to find a gray-level adjustment gain that causes the color temperature to be equal to or approximate the standard 6500K, thereby recording each PWM duty ratio and the corresponding gray-level adjustment gain that can be used to achieve the standard color temperature.

In one example, a look-up table for recording each of the plurality of duty ratios as well as the corresponding gray-level adjustment gain may be obtained based on the above experimental procedure and pre-stored in the display device for implementing the embodiments according to the present invention.

Table 3 below shows an example of a look-up table obtained experimentally for a certain type of backlight module, where each row in the look-up table records a certain duty ratio and the corresponding gray-level adjustment gain Rgain, Ggain, and Bgain, which correspond to red, green, and blue, respectively. Taking the 4th row in Table 3 as an example, it is shown that in a case where the PWM duty ratio is 12.50%, the adjusted display gray-level data (0.900*255, 1.000*255, 0.977*255)=(230,255,249) is obtained by adjusting the initial display gray-level data (255, 255, 255) by the gray-level adjustment gain (0.900, 1.000, 0.977), based on which the gray-level values of the three RGB sub-pixels are set to 230, 255, 249, respectively, for display, and a standard color temperature equal to or close to 6500K can be achieved.

TABLE 3

| PWM duty | | | |
|---|---|---|---|
| ratio | Rgain | Ggain | Bgain |
| 0.00% | 0.896 | 1.000 | 0.975 |
| 6.25% | 0.896 | 1.000 | 0.975 |
| 12.50% | 0.900 | 1.000 | 0.977 |
| 18.75% | 0.898 | 1.000 | 0.975 |
| 25.00% | 0.900 | 1.000 | 0.975 |
| 31.25% | 0.920 | 1.000 | 0.986 |
| 37.50% | 0.932 | 1.000 | 0.990 |
| 43.75% | 0.941 | 1.000 | 0.996 |
| 50.00% | 0.949 | 1.000 | 0.996 |
| 56.25% | 0.955 | 1.000 | 0.998 |
| 62.50% | 0.960 | 1.000 | 1.000 |
| 68.75% | 0.963 | 1.000 | 1.000 |
| 75.00% | 0.968 | 1.000 | 1.000 |
| 81.25% | 0.967 | 1.000 | 1.000 |
| 87.50% | 0.969 | 1.000 | 1.000 |
| 93.75% | 0.974 | 1.000 | 1.000 |
| 100.00% | 1.000 | 1.000 | 1.000 |

It should be noted that the specific format of the look-up table shown in Table 3 is merely an example, and the experiment may be performed for other duty ratios to record corresponding gray-level adjustment gains, or the experiment may be performed for a greater or lesser number of duty ratios to record corresponding gray-level adjustment gains, according to specific needs and without limitation herein. In addition, the gray-level adjustment gain may be implemented with a higher or lower accuracy value, without limitation.

After respective duty ratios as well as the corresponding gray-level adjustment gains are experimentally obtained and recorded, the corresponding gray-level adjustment gain can be retrieved based on the duty ratio currently used in the display driving process, thereby adjusting the display gray-level data of respective pixels.

Accordingly, in this embodiment, adjusting the display gray-level data for each pixel on the display panel based on the duty ratio information to obtain the adjusted display gray-level data comprises: determining a gray-level adjustment gain based on the duty ratio information; and, adjusting the display gray-level data for each pixel on the display panel based on the gray-level adjustment gain to obtain the adjusted display gray-level data. As described for step S201, the duty ratio information may be the duty ratio of the PWM control signal currently employed for controlling the backlight module, or the duty ratio of the PWM control signal may be determined from the duty ratio information. After the duty ratio is obtained, the gray-level adjustment gain corresponding to the obtained duty ratio may be queried, for example, by way of a look-up table.

Among them, the gray-level adjustment gain comprises a gray-level adjustment gain corresponding to one or more colors, and adjusting the display gray-level data for each pixel on the display panel based on the duty ratio information to obtain the adjusted display gray-level data comprises: determining the gray-level adjustment gain corresponding to the one or more colors based on the duty ratio information; and, adjusting the display gray-level data of sub-pixels of a corresponding color based on the gray-level adjustment gain corresponding to the one or more colors to obtain the adjusted display gray-level data. That is, at each PWM duty ratio, the display gray-level data of each sub-pixel may be adjusted based on the following formula with the gray-level adjustment gain corresponding to respective colors:

$$\begin{matrix}Rout = Rgain * Rin \\ Gout = Ggain * Gin \\ Bout = Bgain * Bin\end{matrix}$$

where, as described above, Rgain, Ggain, and Bgain are a gray-level adjustment gain corresponding to red, green, and blue, respectively, Rin, Gin, and Bin are display gray-level data of red, green, and blue sub-pixels of a certain pixel on the display panel, and Rout, Gout, and Bout are adjusted display gray-level data.

By way of example and also based on the 4th row of Table 3, assuming that the duty ratio of the currently employed PWM control signal is 12.50%, the corresponding gray-level adjustment gain can be determined to be (0.900, 1.000, 0.977) by looking up the Table 3, which corresponds to red, green, and blue, respectively. Accordingly, the display gray-level data of each red sub-pixel on the display panel may be adjusted with a gray-level adjustment gain of 0.900 (i.e., the display gray-level data of each red sub-pixel is multiplied by 0.900), and the display gray-level data of each blue sub-pixel on the display panel may be adjusted with a gray-level adjustment gain of 0.977 (i.e., the display gray-level data of each blue sub-pixel is multiplied by 0.977), while the display gray-level data of each green sub-pixel remains unchanged (due to the corresponding gray-level adjustment gain of 1.000), thereby obtaining the adjusted display gray-level data.

After the adjusted display gray-level data is obtained, it may be used by the source driver (e.g., a gamma voltage generator and a plurality of channel circuits included therein) to generate the target data voltage corresponding to each adjusted display gray-level data, as previously described.

Subsequently, in step S203, the target data voltage is applied to data lines on the display panel to control the display panel for display. As previously described, the gate driver may activate/turn on each row of pixels on the display panel row by row, and in a case where a certain row of pixels are activated/turned on, target data voltages corresponding to the row of pixels (i.e., each sub-pixel in the row of pixels) may be applied to the data lines on the display panel, and then the same process is also performed for the next row of pixels, thereby controlling the display panel for display.

Specific details of an embodiment of adjusting the display gray-level data according to the PWM duty ratio are described above. Another embodiment of directly adjusting the data voltage according to the PWM duty ratio will be described in detail hereinafter. Parts that are the same with respect to both of the two embodiments will be omitted or briefly described hereinafter.

In this embodiment where the data voltage is directly adjusted according to the PWM duty ratio, likewise, the duty ratio information for controlling the backlight module may be acquired based on step S201. Subsequently, in Step S02, determining the target data voltage of each pixel on the display panel based at least in part on the duty ratio information comprises: determining a voltage adjustment gain based on the duty ratio information; and, adjusting a data voltage of each pixel on the display panel based on the voltage adjustment gain to obtain the target data voltage.

Likewise, before performing the above steps, it is necessary to first determine in advance the voltage adjustment gains capable of adjusting the data voltages to achieve the standard color temperature by way of experimentation and store them in advance in the memory of the display device. Specifically, in an experiment, each display gray-level data of each pixel on the display panel can be set to a maximum value, and an initial data voltage corresponding to each display gray-level data can be generated by the source driver. Subsequently, the initial data voltage may be adjusted with a different voltage adjustment gain at each PWM duty ratio (i.e., different voltage adjustment gains are multiplied with the initial data voltage respectively to obtain an adjusted target data voltage), and after the adjusted target data voltage is applied to each data line for display, the color temperature of one or more pixels on the display panel is measured with a color temperature measurement device such as a color temperature meter, a color calibrator, etc. to find a voltage adjustment gain that causes the color temperature to be equal to or close to the standard 6500K, thereby recording each PWM duty ratio and the corresponding voltage adjustment gain that can be used to achieve the standard color temperature.

In one example, a lookup table for recording each of the plurality of duty ratios as well as the corresponding voltage adjustment gain may be obtained based on the above experimental procedure and pre-stored in the display device for implementing the embodiments according to the present invention. The form of the look-up table for recording the voltage adjustment gain may similarly take the form corresponding to Table 3, and is not limited herein.

After the respective duty ratios as well as the corresponding voltage adjustment gains are obtained and recorded through experimentation, it is possible to retrieve the corresponding voltage adjustment gain based on the currently used duty ratio in the display driving process, so that the data voltages of respective pixels on the display panel are adjusted based on the voltage adjustment gain obtained through retrieval to obtain the target data voltages.

Among them, the voltage adjustment gain comprises a voltage adjustment gain corresponding to one or more colors, and determining the target data voltage of each pixel on the display panel based at least in part on the duty ratio information comprises: determining the voltage adjustment gain corresponding to the one or more colors based on the duty ratio information; and, adjusting a data voltage of sub-pixels of a corresponding color based on the voltage adjustment gain corresponding to the one or more colors to obtain the target data voltage.

Specifically, assuming that the voltage adjustment gain corresponding to red, green, and blue, respectively, is retrieved as (Rgain′, Ggain′, Bgain′) based on the duty ratio of the currently used PWM control signal, the data voltage of each red sub-pixel on the display panel may be adjusted with the voltage adjustment gain Rgain′ (i.e., multiplying the data voltage of each red sub-pixel by Rgain′), the data voltage of each green sub-pixel on the display panel may be adjusted by the voltage adjustment gain Ggain′ (i.e., multiplying the data voltage of each green sub-pixel by Ggain′), and the data voltage of each blue sub-pixel on the display panel may be adjusted by a voltage adjustment gain Bgain′ (i.e., the data voltage of each blue sub-pixel is multiplied by Bgain′), thereby obtaining the adjusted target data voltage.

Subsequently, in step S203, the target data voltage may be applied to the data lines on the display panel to control the display panel for display.

In summary, the method according to the embodiments of the present disclosure may adjust display gray-level data or data voltages of respective pixels based on the PWM duty ratio for controlling the backlight source, thereby enabling the color temperature displayed by the display panel to be substantially kept consistent at respective PWM duty ratios, reducing the color temperature deviation due to the duty ratio variation, so as to provide a more stable and high quality display effect.

A display control device for a display panel according to an embodiment of the present disclosure is described below, including: means for acquiring duty ratio information for controlling a backlight module; means for determining a target data voltage of each pixel on the display panel based at least in part on the duty ratio information; and, means for applying the target data voltage to data lines on the display panel to control the display panel for display.

According to other aspects of the present disclosure, the display control device may further include means for performing other steps in the method according to the embodiments of the present disclosure.

In addition, a display system according to an embodiment of the present disclosure is also described, comprising: a display panel; a backlight module; an adjustment module, configured to: acquire duty ratio information for controlling the backlight module; adjust display gray-level data of each pixel on the display panel based on the duty ratio information to obtain adjusted display gray-level data; and, a source driver, configured to generate a target data voltage of each pixel on the display panel based on the adjusted display gray-level data, and to apply the target data voltage to data lines on the display panel to control the display panel for display.

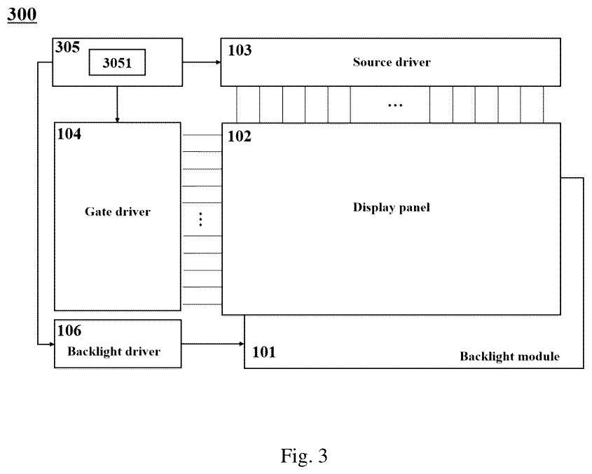

Optionally, the display system further includes a timing controller, and the adjustment module may be located inside the timing controller. FIG. 3 shows a schematic diagram of an LCD display system 300 according to an embodiment of the present disclosure. Compared to the LCD display system 100 in FIG. 1, an adjustment module 3051 is further included within the timing controller 305 of the LCD display system 300 in FIG. 3. As previously described, the timing controller may generally receive the duty ratio information for controlling the backlight module and the display gray-level data for each pixel from an external device such as a GPU, and thus, such information and data may be readily used by the adjustment module 3051 to determine how to adjust the display gray-level data. Accordingly, preferably, various steps for determining the adjusted display gray-level data described according to an embodiment of the present disclosure may be performed by the adjustment module 3051 inside the timing controller. Subsequently, after determining the adjusted display gray-level data, the adjustment module 3051 may pass it to the source driver 103, and the source driver 103 may generate target data voltages of respective pixels on the display panel based on the adjusted display gray-level data (e.g., as described above, with a gamma voltage generator and a plurality of channel circuits included in the source driver 103 itself), and output and apply the target data voltages to data lines on the display panel to control the display panel for display.

In addition, another display system according to an embodiment of the present disclosure is also described, comprising: a display panel; a backlight module; a determination module, configured to: acquire duty ratio information for controlling the backlight module; determine a voltage adjustment gain based on the duty ratio information; and, a source driver, configured to adjust a data voltage of each pixel on the display panel based on the voltage adjustment gain to obtain a target data voltage, and to apply the target data voltage to data lines on the display panel to control the display panel for display.

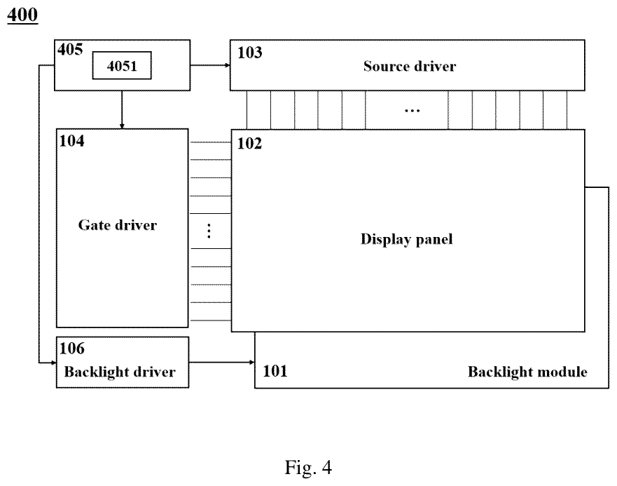

Optionally, the display system may further include a timing controller, and the determination module may be located inside the timing controller. FIG. 4 shows a schematic diagram of an LCD display system 400 according to an embodiment of the present disclosure. Compared to the LCD display system 400 in FIG. 1, a determination module 4051 is further included inside the timing controller 405 of the LCD display system 400 in FIG. 4. As described previously, the timing controller may generally receive duty information for controlling the backlight module from an external device such as a GPU, and thus the determination module 4051 may easily acquire the duty information and determine the voltage adjustment gain based on the duty information. Subsequently, after determining the voltage adjustment gain, the determining module 4051 may pass it to the source driver 103. And after generating the data voltages of respective pixels on the display panel based on the display gray-level data, the source driver 103 may further adjust the data voltages based on the voltage adjustment gain to obtain the target data voltages, so that the target data voltages are applied to the data lines on the display panel to control the display panel to perform display.

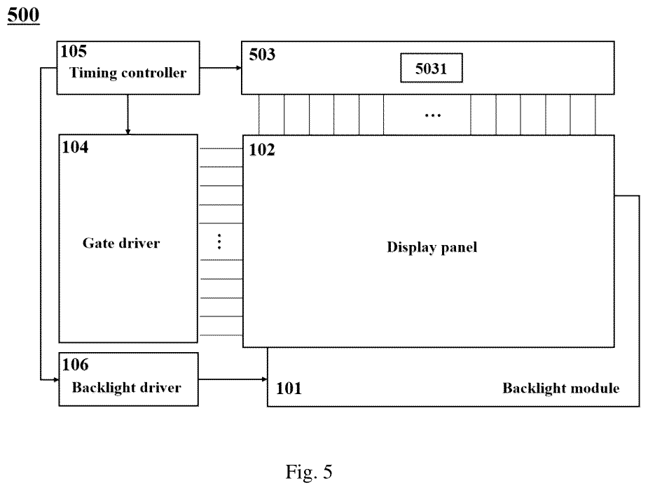

In another example, the determining module may be located inside the source driver. FIG. 5 shows a schematic diagram of an LCD display system 500 according to an embodiment of the present disclosure. Compared to the LCD display system 100 in FIG. 1, a determination module 5031 is further included inside the source driver 503 of the LCD display system 500 in FIG. 5. In this example, the determination module 5031 inside the source driver 503 may acquire duty information for controlling the backlight module from the timing controller 105 and determine the voltage adjustment gain based on the duty information. This voltage adjustment gain may then be used, for example, by a plurality of channel circuits inside the source driver 503 to adjust the data voltages of the respective pixels on the display panel to obtain target data voltages, and to apply the obtained target data voltages to the respective data lines on the display panel to control the display panel to perform display.

The basic principles of the present disclosure are described above in connection with specific embodiments. It is to be noted that the advantages, advantages, effects and the like mentioned in the embodiments of the present disclosure are only examples and not limitations, and these advantages, advantages, effects and the like cannot be regarded as necessarily possessed by the various embodiments of the present disclosure. In addition, the foregoing specific details have been set forth merely for purposes of illustration and understanding, and are not intended to be limiting and are not intended to limit the disclosure to the extent that the specific details must be employed to practice the disclosure. It is also noted that in the devices and methods of the present disclosure, components or steps may be broken down and/or recombined. Such decomposition and/or recombination should be considered equivalent to the present disclosure.

It will be understood by one of ordinary skill in the art that all or any portion of the methods and apparatus of the present disclosure may be implemented in hardware, firmware, software, or a combination thereof in any computing device (including a processor, storage media, etc.) or network of computing devices. The hardware may utilize a general purpose processor, a digital signal processor (DSP), an application specific integrated circuit (ASIC), a field programmable gate array signal (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration. The software may reside in any form of computer-readable, tangible storage medium. By way of example, and not limitation, such computer-readable tangible storage media can comprise RAM, ROM, EEPROM, CD-ROM or other optical disk storage, magnetic disk storage or other magnetic storage devices, or any other tangible medium that can be used to carry or store desired program code in the form of instructions or data structures and that can be accessed by a computer. Disk, as used herein, includes compact disc (CD), laser disc, optical disc, digital versatile disc (DVD), floppy disk and Blu-ray disc.

The block diagrams of elements, components, devices, apparatuses, systems referred to in embodiments of the present disclosure are merely illustrative examples and are not intended to require or imply that they must be connected, arranged, configured in the manner shown in the block diagrams. These elements, components, apparatuses, devices, systems may be connected, arranged, configured in any manner, as would be recognized by those skilled in the art.

Moreover, the claimed scope of the present disclosure is not limited to the specific aspects of the process, machine, manufacture, composition of matter, means, methods, and actions described above. Processes, machines, manufacture, compositions of matter, means, methods, or actions, presently existing or later to be developed, that perform substantially the same function or achieve substantially the same result as the corresponding aspects described herein may be utilized.

Furthermore, words such as “comprising”, “including”, “having” and the like are open-ended words, meaning “including but not limited to” and can be used interchangeably therewith. As used herein, the terms “or” and “and” mean, and are used interchangeably with, the term “and/or” unless the context clearly dictates otherwise. As used herein, the term “such as” means, and is used interchangeably with, the phrase “such as but not limited to”.

The above description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

1. A display control method for a display panel, comprising:
acquiring duty ratio information for controlling a backlight module;
determining a target data voltage of each pixel on the display panel based at least in part on the duty ratio information; and
applying the target data voltage to data lines on the display panel to control the display panel for display.

2. The display control method of claim 1, wherein determining the target data voltage of each pixel on the display panel based at least in part on the duty ratio information comprises:
adjusting display gray-level data for each pixel on the display panel based on the duty ratio information to obtain adjusted display gray-level data; and,
generating the target data voltage based on the adjusted display gray-level data.

3. The display control method of claim 2, wherein adjusting the display gray-level data for each pixel on the display panel based on the duty ratio information to obtain the adjusted display gray-level data comprises:
determining a gray-level adjustment gain based on the duty ratio information; and,
adjusting the display gray-level data for each pixel on the display panel based on the gray-level adjustment gain to obtain the adjusted display gray-level data.

4. The display control method of claim 3, wherein the gray-level adjustment gain comprises a gray-level adjustment gain corresponding to one or more colors, and adjusting the display gray-level data for each pixel on the display panel based on the duty ratio information to obtain the adjusted display gray-level data comprises:
determining the gray-level adjustment gain corresponding to the one or more colors based on the duty ratio information; and,
adjusting the display gray-level data of sub-pixels of a corresponding color based on the gray-level adjustment gain corresponding to the one or more colors to obtain the adjusted display gray-level data.

5. The display control method of claim 3, wherein determining the gray-level adjustment gain based on the duty ratio information comprises:
determining the gray-level adjustment gain by a pre-stored look-up table, wherein the look-up table is used to record each of a plurality of duty ratios and a corresponding gray-level adjustment gain.

6. The display control method of claim 1, wherein determining the target data voltage of each pixel on the display panel based at least in part on the duty ratio information comprises:
determining a voltage adjustment gain based on the duty ratio information; and,
adjusting a data voltage of each pixel on the display panel based on the voltage adjustment gain to obtain the target data voltage.

7. The display control method of claim 6, wherein the voltage adjustment gain comprises a voltage adjustment gain corresponding to one or more colors, and determining the target data voltage of each pixel on the display panel based at least in part on the duty ratio information comprises:
determining the voltage adjustment gain corresponding to the one or more colors based on the duty ratio information; and,
adjusting a data voltage of sub-pixels of a corresponding color based on the voltage adjustment gain corresponding to the one or more colors to obtain the target data voltage.

8. The display control method of claim 6, wherein determining the voltage adjustment gain based on the duty ratio information comprises:
determining the voltage adjustment gain by a pre-stored look-up table, wherein the look-up table is used to record each of a plurality of duty ratios and a corresponding voltage adjustment gain.

9. A display control device for a display panel, comprising:
means for acquiring duty ratio information for controlling a backlight module;
means for determining a target data voltage of each pixel on the display panel based at least in part on the duty ratio information; and,
means for applying the target data voltage to data lines on the display panel to control the display panel for display.

10. A display system, comprising:
a display panel;
a backlight module;
an adjustment module, configured to:
acquire duty ratio information for controlling the backlight module;
adjust display gray-level data of each pixel on the display panel based on the duty ratio information to obtain adjusted display gray-level data; and,
a source driver, configured to generate a target data voltage of each pixel on the display panel based on the adjusted display gray-level data, and to apply the target data voltage to data lines on the display panel to control the display panel for display.

11. The display system of claim 10, wherein the display system further comprises a timing controller, and the adjustment module is located inside the timing controller.

12. A display system, comprising:
a display panel;
a backlight module;
a determination module, configured to:
acquire duty ratio information for controlling the backlight module;
determine a voltage adjustment gain based on the duty ratio information; and,
a source driver, configured to adjust a data voltage of each pixel on the display panel based on the voltage adjustment gain to obtain a target data voltage, and to apply the target data voltage to data lines on the display panel to control the display panel for display.

13. The display system of claim 12, wherein the display system further comprises a timing controller, and the determination module is located inside the timing controller.

14. The display system of claim 12, wherein the determining module is located inside the source driver.
